(19) United States
(12) Patent Application Publication
(10) Pub. No.: US 2007/0097864 A1
(43) Pub. Date: May 3, 2007

(54) Data communication flow control

(75) Inventor: Alon Shlomo Bernstein, Sunnyvale, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Cisco Technology, Inc.

(21) Appl. No.: 11/263,871

(22) Filed: Nov. 1, 2005

(51) Int. Cl. H04L 12/26

(52) U.S. Cl. 370/232; 370/468

(57) ABSTRACT

A method and system to manage data traffic includes monitoring a characteristic of input data to a buffer located, for example a buffer located in a communication line card. The transmission of the input data is maintained while reducing an effective transmission rate of the input data based upon either a data rate of the input data, or a volume of the input data accumulated in the buffer. Embodiments provide granular control and avoid disruptive turning on and off of the data communication.

### TECHNICAL FIELD

This application relates to data traffic control in communication systems.

### BACKGROUND

A computer network is a distributed collection of interconnected communication links for transporting data between nodes, such as computers. Many types of computer networks are available, with the types ranging from local area networks (LANs) to wide area networks (WANs). The nodes typically communicate by exchanging frames or packets of data according to pre-defined protocols, such as the Transmission Control Protocol/Intertnet Protocol (TCP/IP).

The topology of a computer network can vary greatly. For example, the topology may comprise a single LAN containing a single intermediate node of a type such as, e.g., a hub, with end-nodes attached to the hub. A more complex network may contain one or more local area networks interconnected through a complex intermediate internetwork comprising a plurality of other types of intermediate nodes, such as switches or routers, to form a WAN. Each of these latter intermediate nodes typically contain a central processor that enables the intermediate node to, inter alia, route or switch the packets of data along the interconnected links from, e.g., a source end-node that originates the data to a destination end-node that is designated to receive the data. Often, these intermediate nodes employ packet buffers to temporarily hold packets that are processed by the nodes.

Packet buffers often comprise one or more memory devices that are arranged to form one or more First-In First-Out (FIFO) queues where each queue is associated with a particular input or output line. The size of each FIFO queue often depends on the rate of the line associated with the queue, as well as the time it takes for a packet to be processed by the intermediate node.

Data traffic management often depends upon the buffers. While the buffers can enable smooth traffic flow, they can also impede efficient operation. That is, if the buffer cannot process the incoming data fast enough, the buffer provides control feedback to stop the incoming data. Starting and stopping the data from an upstream router can significantly degrade data traffic flow.

### BRIEF DESCRIPTION OF DRAWINGS

Embodiments of the present invention are illustrated by way of example and not limitation in the figures of the accompanying drawings, in which like references indicate similar elements and in which:

FIG. 1 is a block diagram of a system according to an example embodiment;

FIG. 2 is a prior art flow control diagram;

FIG. 3 is a flow rate diagram according to an example embodiment;

FIG. 4 is a flow control diagram according to another example embodiment;

FIG. 5 is a flow control diagram according to another example embodiment;

FIG. 6 is a flow chart of a method 600 for data traffic control in accordance with an example embodiment; and

FIG. 7 is a flow chart of another example embodiment.

### DETAILED DESCRIPTION

In the following detailed description of example embodiments, reference is made to the accompanying drawings which form a part hereof, and in which is shown by way of illustration specific embodiments in which the example method and system may be practiced. It is to be understood that other embodiments may be utilized and structural changes may be made without departing from the scope of this description.

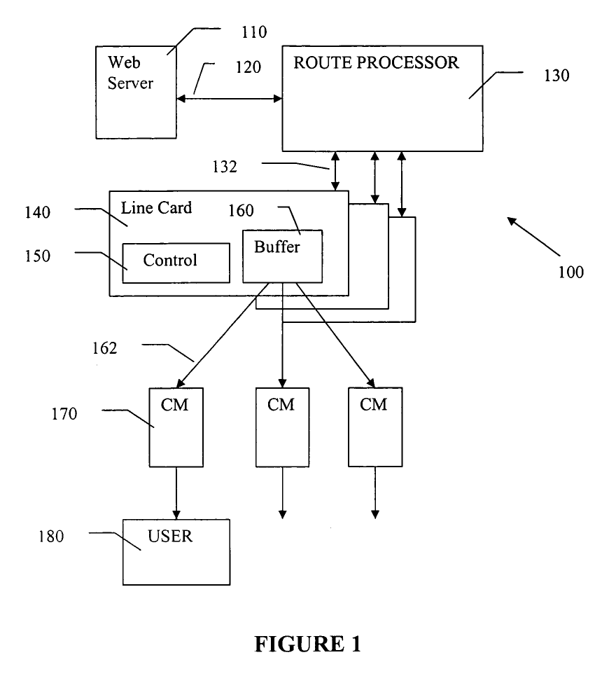

Referring to FIG. 1, a communication system 100 according to an example embodiment is described. The system 100 includes a route processor 130 coupled to route data from an input 120 to multiple outputs/interconnects 132. The outputs are coupled to line cards 140 which are in turn coupled to multiple interconnects 162, such as cable modems 170. The cable modems are coupled to a user 180, such as a personal computer. The system 100 is a bidirectional communication system, however, embodiments of the present invention are focused, by way of example, on down stream communication from the route processor to the line cards.

As an example, the user can be a personal computer performing web browsing. The user enters a request, such as a URL (Uniform Resource Locator), which is communicated to the Internet (input 120) coupled to the route processor 130. A web server 110 responds to the URL and communicates information downstream toward the user.

The route processor 130 includes router logic that makes decisions on downstream communications. In general, the router may decide which interconnect 132 to route the downstream data. The line cards 140 typically include buffer(s) 160 to buffer communications to users. For example, the cable modem interface physically cannot send more then a certain number of bits per second and the buffer allows for the accumulation of data sent from the route processor which exceeds the interface bandwidth. At times, the downstream communications can fill the buffer. As such, the line cards have control logic 150 to provide flow control signal(s) that provides feedback to the route processor 130.

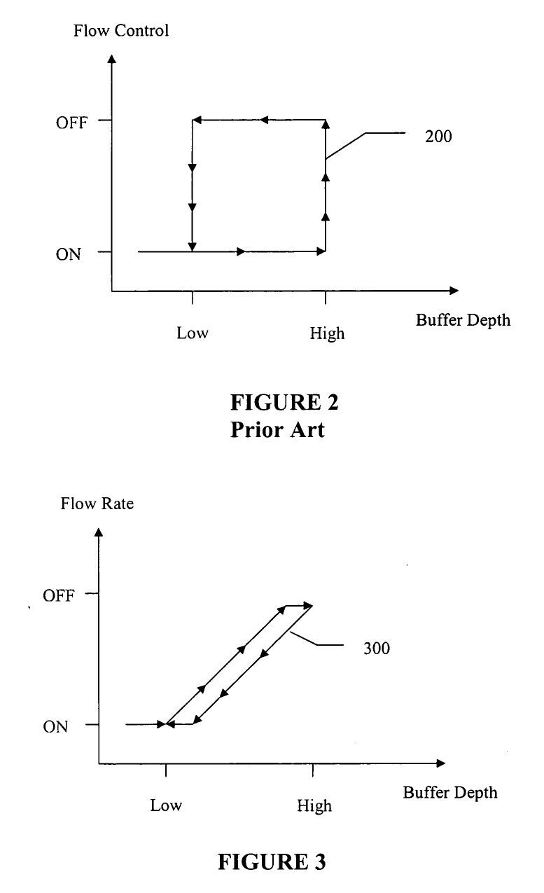

In prior art systems, the flow control instructs the scheduler to start and stop the downstream data flow based upon thresholds of the buffer. Referring to FIG. 2, a prior art control flow diagram 200 is described. The downstream data flow from the route processor is enabled, or ON, while the buffer depth is below a High level. When the buffer depth reaches the High limit, a signal(s) is sent to the route processor to turn the data flow OFF. As data is removed from the buffer the buffer depth decreases to the LOW level and the downstream data flow is again turned on. Those skilled in the art will appreciate that the binary control of the downstream flow can cause disruptions in traffic control by the route processor.

FIG. 3 illustrates a flow rate diagram 300 of an example embodiment. The downstream data flow from the route processor is enabled, or ON, while the buffer depth is below a Low level. When the flow control is ON, the Route Processor transmits to the buffer in an uninterrupted manner. When the buffer depth reaches the Low limit, the downstream data flow is reduced, but not completely stopped. If the buffer depth continues toward the a High level, the flow rate is further reduced. If the buffer depth does reach the High level, the downstream data is turned off.

As data is removed from the buffer the buffer depth decreases toward the LOW level and the downstream data flow is correspondingly increased. The variable flow control rate of FIG. 3 reduces the prior art problems with binary flow rate control.

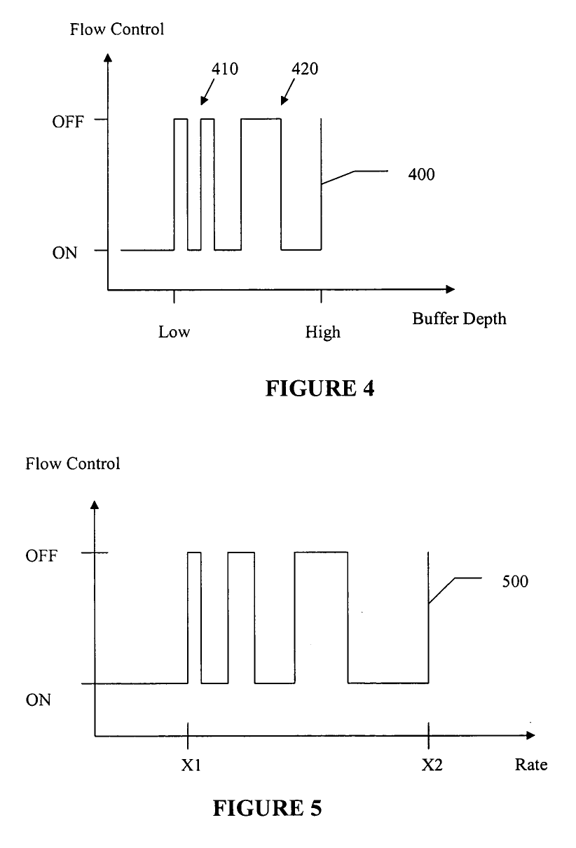

An example embodiment for achieving the variable flow rate of FIG. 3 is described with reference to FIG. 4. The downstream data flow from the route processor is enabled, or ON, while the buffer depth is below a Low level. When the buffer depth exceeds the Low level, control signals 400 are is sent to the route processor to toggle the data flow ON and OFF at a first frequency rate 410. If the buffer depth continues to fill, the frequency of the control signal toggle is decreased to a second frequency 420 from the first frequency rate. If the buffer reaches the High level, the downstream data flow is stopped. As data is removed from the buffer the buffer depth decreases toward the LOW level and the downstream data flow toggled at the different frequency rates. The flow control diagram of FIG. 4 has been simplified to illustrate the variable toggle frequency rates and it will be appreciated that more frequency rates can be implemented in different embodiments.

Alternatively, the flow rate control of FIG. 3 can be implemented in some embodiments by monitoring the downstream flow rate from the route processor. For example, the buffer may begin to fill up if the flow rate exceeds the maximum flow rate allowed by the line card connection to the user. As such, controlling the flow rate without monitoring the buffer can be achieved by predicting the buffer depth through monitoring the downstream communication rate. The present embodiments are not limited to a specific device or algorithm for monitoring the data rate. In an embodiment, a token bucket algorithm is implemented by the line card to determine actual flow rate.

As known to those skilled in the art, a token bucket generally refers to packet transfer technology that accommodates data bursts. Conceptually, one or more tokens are required to forward network messages. Tokens are acquired at a certain rate and are placed in a “bucket”. Once the bucket is full, any additional tokens are simply discarded. As traffic is received, if sufficient tokens are present in the bucket, the traffic may be forwarded, causing the requisite number of tokens to be “consumed”. If insufficient tokens are present, the traffic must be delayed until more tokens are received. Thus, the token bucket scheme accommodates data bursts, but ensures that the long-term transmission rate does not exceed the established rate at which tokens are placed in the bucket.

The output of the token bucket can be maintained at a constant rate. For example, the output rate can be set to a maximum allowed data rate for the line card to user interface. If the data rate into the token bucket from the route processor is greater than an allowed output of the line card, the token bucket accumulates tokens. The token algorithm can detect the token accumulation and adjust the route processor downstream communication. In an embodiment, the token algorithm implements a variable flow control, as explained above, to slow the communication rate from the route processor.

In another embodiment, referring to FIG. 5, the token algorithm toggles the flow control 500 at different frequencies to slow the communication rate from the route processor. As illustrated, if the data transmission rate exceeds a first data rate (X1), flow control signals can be transmitted to the route processor by the line card. If the transmission rate is greater than rate X1, but less than rate X2, the flow control signal frequency can be reduced to effectively reduce the transmission rate from the route processor. Alternatively, a single rate X1 can be used in an example embodiment. In this embodiment, the line card may modulate the flow control signal to control the downstream transmission to reduce the effective transmission rate.

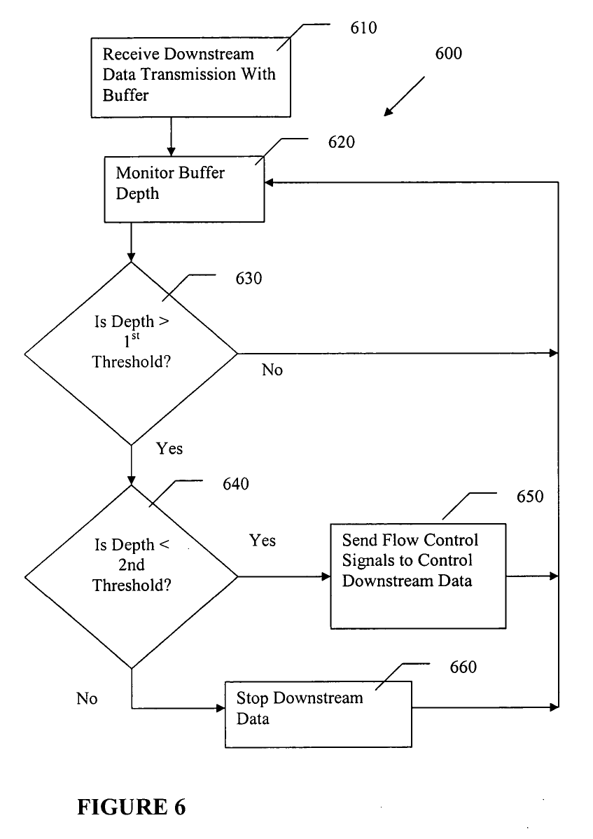

Referring to FIG. 6, a flow chart illustrating a method 600 for data traffic control in accordance with an example embodiment is described. At step 610 a buffer, for example located at a line card, receives input data from an upstream device. At step 620, the buffer depth is monitored. If the buffer depth is greater than a first lower level (1^{st} Threshold) at step 630 and less than a second higher level (2^{nd} Threshold) at step 640, a series of flow control signals are transmitted at step 650 to stop and start the input data transmission from the upstream device. A frequency of the series of flow control signals is varied based upon the buffer depth. At step 660, if the buffer depth exceeds the second higher level a flow control signal is transmitted to stop the input data transmission from the upstream device.

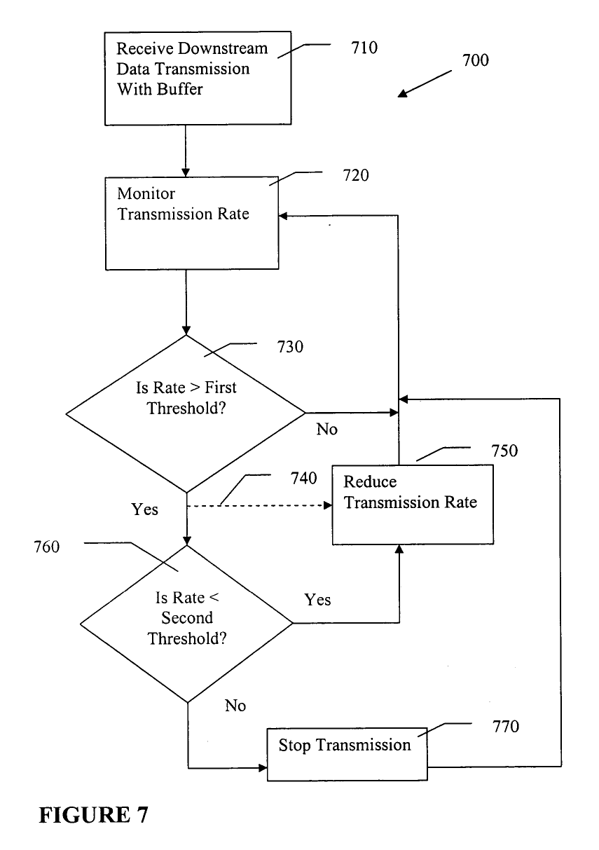

Referring to FIG. 7, a flow chart illustrating a method 700 of data traffic control in accordance with an example embodiment is described. At step 710 a buffer, for example located at a line card, receives input data from an upstream device. At step 720, the transmission rate is monitored. If the transmission rate is above a first threshold rate, at step 730, and less than a second threshold rate, at step 760, the transmission rate from the upstream device is reduced at step 750. Alternatively, if the transmission rate is above a first threshold rate, at step 730, the transmission rate from the upstream device at step 750 (see dashed line 740). At step 770, if the transmission rate exceeds the second threshold rate, the input data transmission from the upstream device is stopped.

To control the assertion of flow control a token bucket can be used. In an example embodiment, a token bucket is used to meter out the duration and rate of flow control. For example, it may monitor “flow control” tokens that are accumulating at a line rate. The “burst size” of the token bucket may control the longest period that a flow control can be asserted continuously, and the “peak rate” may control how frequently flow control is asserted. Unlike a regular token bucket that is used to control the sending of data (e.g., bytes) the token bucket in an embodiment is used to stop bytes from being transmitted. The “burst size” may control how long the flow control has to be asserted. The “peak rate” may control how frequently the flow control is asserted.

The embodiments described herein may be implemented in an operating environment comprising software or in a combination of software and hardware. The software and/or hardware would typically include some type of computer-readable media which can store data and logic instructions that are accessible by processing logic within the hardware. Such media might include, without limitation, hard disks, floppy disks, flash memory cards, digital video disks, random access memories (RAMs), read only memories (ROMs), and the like.

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method of data traffic control comprising:
monitoring a characteristic of input data to a buffer located in a communication line card; and
maintaining a transmission of the input data while reducing an effective transmission rate of the input data based upon the monitoring the characteristic of input data.

2. The method of claim 1 wherein the characteristic of the input data is a data rate of the input data.

3. The method of claim 1 wherein the characteristic of the input data is a volume of the input data accumulated in the buffer.

4. The method of claim 1 further comprises providing feedback control to an upstream device transmitting the input data, wherein the feedback control modulates the input data transmission to reduce the effective transmission rate.

5. The method of claim 1 wherein maintaining the transmission of the input data comprises implementing a token bucket algorithm.

6. A machine-readable medium embodying instructions which, when executed by a machine, cause the machine to claim 1.

7. A method of data traffic control comprising:
monitoring a buffer depth of a buffer receiving input data; and
maintaining a transmission of the input data by reducing an effective transmission rate of the input data when the monitored buffer depth reaches a first threshold level.

8. The method of claim 7 wherein reducing a transmission rate further comprises providing flow control feedback signals to an upstream device transmitting the input data.

9. The method of claim 8 wherein the flow control feedback signals start and stop the transmission of the input data at a first frequency when the monitored buffer depth reaches the first threshold level.

10. The method of claim 9 wherein the flow control feedback signals start and stop the transmission of the input data at a second frequency when the monitored buffer depth exceeds the first threshold level.

11. A machine-readable medium embodying instructions which, when executed by a machine, cause the machine to claim 7.

12. A communication system comprising:
a downstream device for receiving data transmitted by an upstream device;
a buffer located with the downstream device; and
control logic coupled to control the data transmitted by the upstream device, wherein the control logic adjusts an effective transmission rate of the data transmitted based upon an available capacity of the buffer.

13. The communication system of claim 12 wherein the control logic monitors the buffer capacity and provides flow control signals to adjust the effective transmission rate of the data transmitted, and wherein the flow control signals reduce effective transmission rate as the buffer capacity reduces.

14. The communication system of claim 13 wherein the flow control signals are modulated at a frequency dependant upon the buffer capacity.

15. The communication system of claim 12 wherein the control logic predicts the buffer capacity by monitoring a transmission rate of the data transmitted by the upstream device, and provides flow control signals to adjust the effective transmission rate of the data transmitted, and wherein the flow control signals reduce effective transmission rate as the buffer capacity reduces.

16. The communication system of claim 15 wherein the control logic implements a token bucket algorithm to monitor the transmission rate.

17. A line card comprising:
a buffer to receive input data and transmit the input data as output data; and
control logic coupled to control the input data transmitted to the buffer, wherein the control logic adjusts an effective transmission rate of the input data based upon an available capacity of the buffer.

18. The line card of claim 17 wherein the control logic monitors the buffer capacity and provides flow control signals to adjust the effective transmission rate of the data transmitted, wherein the flow control signals are modulated at a first frequency when the available buffer capacity reaches a first threshold level.

19. The line card of claim 18 wherein the flow control signals are modulated at a second lower frequency when the available buffer capacity decreased beyond the first threshold level.

20. The line card of claim 17 wherein the control logic predicts the buffer capacity by monitoring a transmission rate of the input data.

21. The line card of claim 20 wherein the control logic implements a token bucket algorithm to monitor the transmission rate.

22. An line card comprising:
means for monitoring a characteristic of input data to a buffer located in a communication line card; and
means for maintaining a transmission of the input data while reducing an effective transmission rate of the input data based upon the monitoring of a characteristic of input data.
